(19) United States
(12) Patent Application Publication
(10) Pub. No.: US 2012/0177046 A1
(43) Pub. Date: Jul. 12, 2012

(54) NETWORK NODE

(75) Inventors: Masaki YAMADA, Yokohama (JP); Yuji OGATA, Saitama (JP); Nobuyuki MURANAKA, Fujisawa (JP)

(73) Assignee: HITACHI, LTD., Tokyo (JP)

(21) Appl. No.: 13/344,214

(22) Filed: Jan. 5, 2012

(30) Foreign Application Priority Data
Jan. 7, 2011 (JP) 2011-002118

(51) Int. Cl. H04L 12/28; H04L 12/56

(52) U.S. Cl. 370/392; 370/389

(57) ABSTRACT

In a network node, when highly sophisticated processing such as filtering is implemented, a phenomenon in which, as the processing becomes more highly sophisticated, a time required for the processing becomes long, and as a result, a delay time of packet forwarding is prolonged, is prevented from occurring. The network node of the present invention performs packet forwarding control for controlling a destination of a packet in parallel with packet forwarding processing for searching for the destination, so that the network node realizes high-speed packet forwarding processing while performing forwarding control by packet monitoring.

### CLAIM OF PRIORITY

The present application claims priority from Japanese patent application JP 2011-002118 filed on Jan. 7, 2011, the content of which is hereby incorporated by reference into this application.

### FIELD OF THE INVENTION

The field of the present invention relates to a network node, in particular to an advanced network node having arithmetic ability and highly sophisticated information processing capability other than normal forwarding process capability.

### BACKGROUND OF THE INVENTION

As network traffic increases and applications are complicated, recent network nodes have not only simple packet forwarding capability, but also capability to implement highly sophisticated processing. As an example of a use of a network node that implements such highly sophisticated processing, there is an idea of a highly sophisticated network node that performs a process related to an application on a network between a user terminal and a data center. Such a highly sophisticated network node realizes an efficient traffic and vicarious execution of arithmetic processing on the network by performing filtering processing and arithmetic processing on data forwarded to the data center.

To realize such complex processing, there is an example of a network node which includes multiple processors therein and in which the processors jointly performs a process. In an example of a device described in Japanese Unexamined Patent Application Publication No. 2003-188936, a process is divided and performed by multiple processors while a received packet is forwarded among the processors.

### SUMMARY OF THE INVENTION

When a packet is forwarded via a network node (hereinafter referred to as node), the node that receives the packet refers to address information included in the header of the packet and retrieves information of destination to which the packet is forwarded. The node forwards the packet to an appropriate transmission destination on the basis of the information obtained from the search result. At this time, there is a case in which a specific processor in the node is selected as a destination instead of an external device connected to the node. In the example of Japanese Unexamined Patent Application Publication No. 2003-188936, a reception processor selects a packet processor to which the packet is forwarded on the basis of the search result. When highly sophisticated processing is required, the packet is forwarded to a target processor and a process is performed on the packet. The destination of the packet on which the process is performed is determined again, and the packet is forwarded to the next destination on the basis of the determination result.

In this way, in a process in the node, packets are transmitted in series and processes are performed sequentially. However, in this process, the higher the function of the node is, the more processors need to forward a packet. Therefore, processes of the processors tend to take longer time. Further, to abide by the principle of first-in first-out in which the packets are forwarded so as not to change the sequence of the traffic, packets of the same flow have to be forwarded in synchronization with a packet having the largest delay time.

Therefore, there is a problem that the more highly sophisticated an implemented process is, the longer the delay time of the packet in the node tends to be.

In view of the above problem, an object of the present invention is to provide a network node which prevents a phenomenon in which a forwarding delay time taken from when a packet is received by the network node to when the packet is forwarded from the network node to another forwarding device when highly sophisticated processing is performed in the network node becomes significantly longer than a delay time when the highly sophisticated process is not performed and shortens the forwarding delay time.

To address the above problem, the network node of the present invention is a network node which includes a function for connecting to multiple lines and a packet forwarding function for referring to header information of a packet received from the multiple lines, searching for a network line connected to a network node that is the destination of the packet, and outputting the packet to the network line connected to the network node that is the destination of the packet on the basis of a result of the search. Further, the network node of the present invention is a network node which includes one or more modules having a function to perform processing other than the forwarding processing. Furthermore, the network node of the present invention is a network node which has a packet analysis function for referring to and analyzing header information or payload information of a received packet or both of the header information and the payload information in order to determine forwarding of the received packet to the module and forwarding the received packet to the module on the basis of a result of the analysis. Furthermore, the network node of the present invention is a network node in which the packet forwarding function and the packet analysis function can be performed on a packet independently from each other.

According to an aspect of the present invention,

for example, a network node includes

an interface that receives a packet including sensor data measured by a sensor,

a packet forwarding unit that performs packet forwarding processing for forwarding the received packet, and

a packet processing unit that performs at least predetermined processing other than the packet forwarding processing on the sensor data included in the received packet,

in which a received packet is inputted into the packet forwarding unit and the packet processing unit respectively, and

the packet forwarding processing by the packet forwarding unit and the processing by the packet processing unit are performed in parallel.

According to another aspect of the present invention,

a network node includes

a first interface that receives a packet including sensor data measured by a sensor,

a second interface that communicates with a data center,

a packet forwarding unit that performs packet forwarding processing for forwarding a packet received by the first interface to the data center via the second interface, and

a packet processing unit that performs at least predetermined processing other than the packet forwarding processing on the sensor data included in the packet received by the first interface and processes a control packet that is received from the data center by the second interface,

in which the packet received by the first interface is inputted into the packet forwarding unit and the packet processing unit respectively,

the packet forwarding processing by the packet forwarding unit and the processing by the packet processing unit are performed in parallel, and

the control packet received by the second interface is inputted into the packet processing unit and processed by the packet processing unit.

According to still another aspect of the present invention, a network node includes

a packet forwarding unit in which filtering information to determine whether a packet is allowed to be forwarded or discarded is stored and which determines whether a received packet is allowed to be forwarded or discarded by referring to the filtering information and performs packet forwarding processing for forwarding a packet allowed to be forwarded according to destination information; and

a packet processing unit that performs at least predetermined processing other than the packet forwarding processing on a received packet,

in which a received packet is inputted into the packet forwarding unit and the packet processing unit respectively, and

the packet forwarding processing by the packet forwarding unit and the processing by the packet processing unit are performed in parallel, and

the destination information and/or the filtering information are updated according to a result of the processing and the packet forwarding processing is performed on a packet received thereafter by referring to the updated destination information and/or filtering information.

According to the aspects of the present invention, there can be provided a network node which prevents a phenomenon in which a forwarding delay time taken from when a packet is received by the network node to when the packet is forwarded from the network node to another forwarding device when highly sophisticated processing is performed in the network node becomes longer than a delay time when the highly sophisticated processing is not performed and shortens the forwarding delay time.

### BRIEF DESCRIPTION OF THE DRAWINGS

FIG. 1 is a configuration diagram of a network node that performs packet forwarding control in parallel with packet forwarding processing;

FIG. 2 is a configuration diagram of a packet forwarding unit of a network node that performs packet forwarding control in parallel with packet forwarding processing;

FIG. 3 is a configuration diagram of a packet forwarding control unit of a network node that performs packet forwarding control in parallel with packet forwarding processing;

FIG. 4 is an illustration of a service that connects multiple home networks;

FIG. 5 is a configuration diagram of a home gateway of a service that connects multiple home networks;

FIG. 6 is a configuration diagram of a highly sophisticated processing block of the home gateway;

FIG. 7 is a configuration diagram of a device control system that uses a monitor camera and a sensor;

FIG. 8 is a configuration diagram a network node of a device control system that uses a monitor camera and a sensor;

FIG. 9 is a configuration diagram of a packet forwarding unit of the network node;

FIG. 10 is a configuration diagram of a highly sophisticated processing block of the network node;

FIG. 11 is a configuration diagram of a monitoring system of a sensor network;

FIG. 12 is a schematic configuration diagram of a sensor network control node;

FIG. 13 is a configuration diagram of a packet forwarding unit of a sensor network control node;

FIG. 14 is a configuration diagram of a sensornet control unit of a sensor network control node;

FIG. 15 is a configuration diagram of a sensornet control table; and

FIG. 16 is an example of a process flow in a sensor network control node.

### DETAILED DESCRIPTION OF THE PREFERRED EMBODIMENTS

### First Embodiment

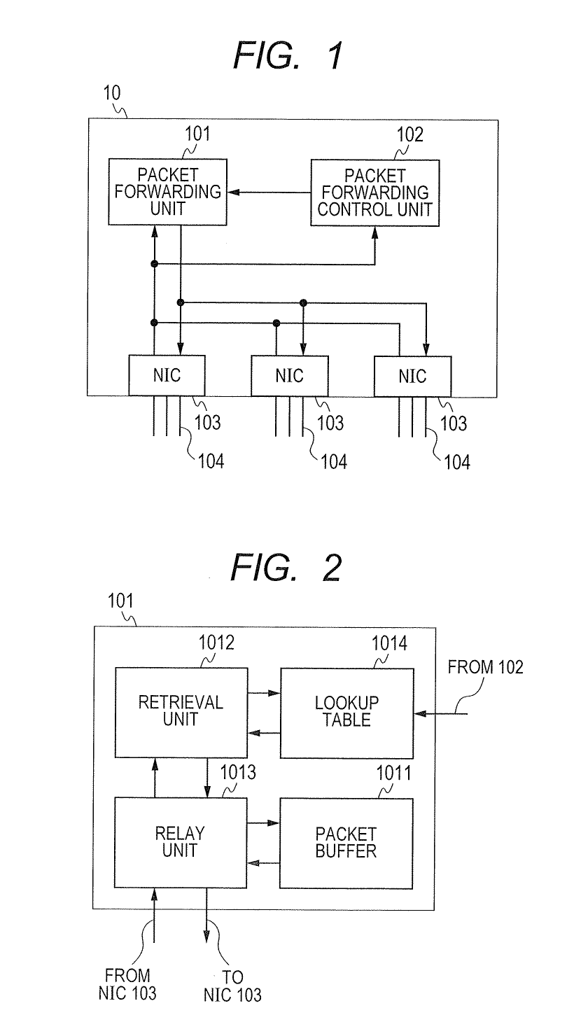

FIG. 1 shows a configuration of an embodiment of the present invention.

A network node 10 of the present embodiment includes a packet forwarding unit 101, a packet forwarding control unit 102, and multiple network interface cards (hereinafter, and in the drawings, referred to as NIC) 103. The NICs 103 are respectively connected to one or more network lines 104, and the network lines 104 are connected to other network nodes and terminals. The network node 10 receives a packet from another node or a terminal device via the network line 104 by using the NIC 103. The received packet is transmitted to the packet forwarding unit 101 and the packet forwarding control unit 102. For example, the packet is copied and transmitted. The packet forwarding unit 101 retrieves a destination of the packet and determines an address, and then the packet forwarding unit 101 transmits the packet to an appropriate NIC 103 on the basis of information of the destination obtained by the search. The NIC 103 that receives the packet from the packet forwarding unit 101 transmits the packet by selecting an appropriate network line 104.

The packet forwarding control unit 102 that receives the packet from the NIC 103 analyzes the packet and rewrites information of a table used for the search by the packet forwarding unit 101 on the basis of the analysis result.

FIG. 2 shows an internal structure of the packet forwarding unit 101. The packet forwarding unit 101 includes a packet buffer 1011 for storing a packet, a retrieval unit 1012 that performs a search based on header information of the packet, a relay unit 1013 that extracts the header information and forwards the header information to the retrieval unit 1012 while relaying the packet transmitted from the NIC to the packet buffer 1011, and a lookup table 1014 that is a memory for storing information which the retrieval unit 1012 retrieves the destination information, QoS information, and the like. The retrieval unit 1012 that receives retrieval results such as the destination information and the QoS information from the lookup table 1014 transmits processing contents of the packet according to the retrieval results to the relay unit 1013. The relay unit 1013 reads the packet data stored in the packet buffer 1011 and forwards the packet data to an appropriate destination or discards the stored packet data on the basis of the received processing contents.

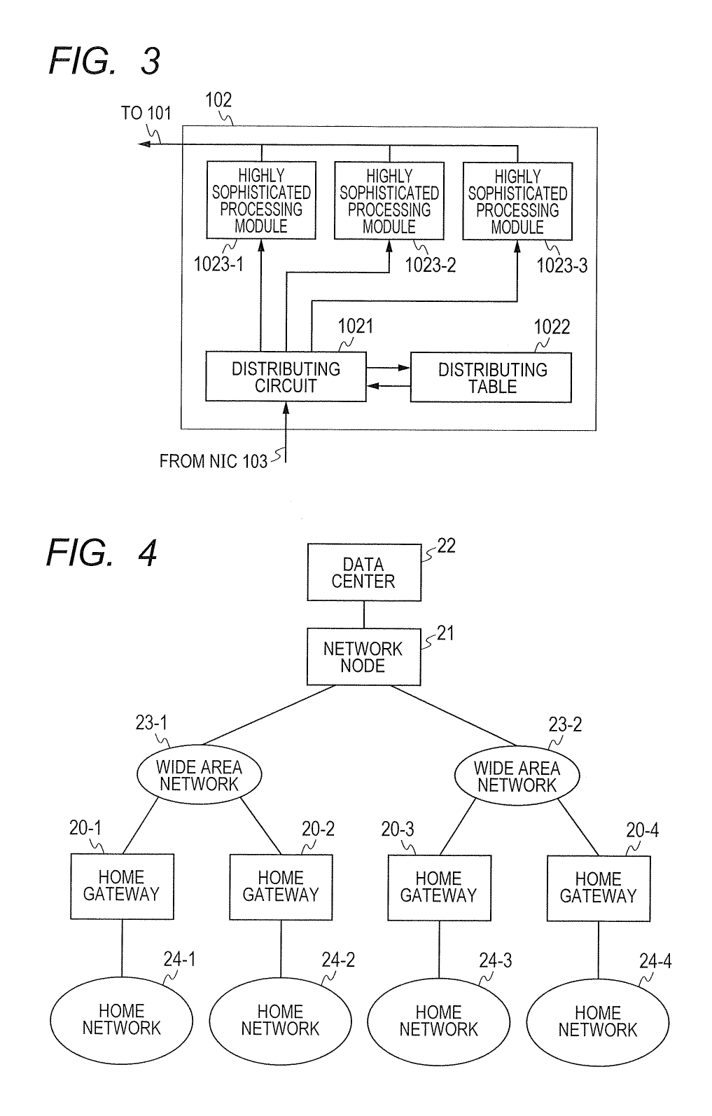

FIG. 3 shows an internal structure of the packet forwarding control unit 102. The packet forwarding control unit 102 includes a packet distributing circuit 1021 for distributing packets, a distributing table 1022 to which the packet distributing circuit 1021 refers, and multiple highly sophisticated processing modules 1023 to which the distributing table 1022 forwards packet information. The packet transmitted from the NIC 103 is forwarded to a corresponding highly sophisticated processing module 1023 via the packet distributing circuit 1021. If there is no corresponding distributing destination in a retrieval result of the distributing table 1022, the packet is discarded. The highly sophisticated processing module 1023 has a function to rewrite the information in the lookup table 1014 in the packet forwarding unit 101 from information of a packet, and the highly sophisticated processing module 1023 rewrites the lookup table 1014 according to a monitoring result of a packet to be monitored. Examples of rewriting include changing a destination of the packet, rewriting the QoS information of the packet, and instructing to discard part or all of the packet.

By using the above configuration, the network node 10 can perform arithmetic processing by the highly sophisticated processing module 1023 while forwarding a received packet. Thereby, the even if the arithmetic processing in the highly sophisticated processing module 1023 takes time, it is possible to perform packet forwarding processing at high speed. When the highly sophisticated processing module 1023 determines that the lookup table 1014 needs to be rewritten, even if the corresponding packet has already been forwarded, the rewriting processing in the highly sophisticated processing module 1023 is continued and the rewritten information is reflected on subsequent packets.

### Second Embodiment

FIG. 4 shows a configuration of another embodiment of the present invention. FIG. 4 shows a network system that provides a service by connecting a data center 22 with a home network 24 via a home gateway 20, a network node 21, and a wide area network 23. In the present embodiment, a configuration of the present invention is applied to the home gateway 20. Although, the present embodiment is described as a home gateway, it is not limited to this, and the present embodiment may be any network node.

The home network 24 can also be used as a limited network generally used in a specific building or area in addition to a network used in a home. For example, the home network 24 can be applied to a network in a company including an office and a factory and a public network such as a network in a public facility, an educational institution, and a government office.

The wide area network 23 is a network for connecting multiple home gateways 20 with the network node 21. Examples of the wide area network 23 include a communication carrier network, a VPN network, and a dedicated line network.

Data generated in a home network 24-1 is transmitted to the data center 22 via a home gateway 20-1, a wide area network 23-1, and the network node 21. However, data that is determined not to be transmitted by the home gateway 20 or the network node 21 may not be transmitted to the data center 22 and may be discarded on the way to the data center 22.

An object of the present system is to forward data generated in the home network 24 to the data center 22 and process the data by an application or accumulate the data, and also to perform a series of highly sophisticated processing such as filtering processing, encryption processing, and high-speed response from monitoring data in the home gateway 20 and the network node 21 on the way to the data center 22. In such a system, if a conventional home gate way 20 and a conventional network node 21 are used, there is a problem that the higher level and the more diversified the highly sophisticated processing is, the longer the time required to complete the forwarding in which the packet passes through the node.

This is because the conventional node determines whether or not the highly sophisticated processing is required after receiving a packet, and determines a destination of the packet after performing the highly sophisticated processing as needed. Therefore, even when the packet does not require the highly sophisticated processing, the packet is not transmitted until it is determined whether or not the highly sophisticated processing is required. This may be because, when the highly sophisticated processing such as filtering is performed, it is not possible to determine a condition of the filtering until the highly sophisticated processing is performed.

As another configuration, a method is considered in which a forwarding engine determines the destination and at the same time determines whether or not the highly sophisticated processing is required. However, in this method, there is a problem that the throughput of the entire device degrades due to an increase in the size of the lookup table caused by complex determination condition of the destination, an increase in time required for the retrieval, and a compression of bandwidth of a switching bus caused by copying and forwarding the packet by the forwarding engine.

To address the above problem, for example, for traffic forwarded to the data center 22 or the like, which does not require highly sophisticated processing, or traffic which is required to forward an original packet independently from the highly sophisticated processing, the home gateway 20 of the present embodiment realizes a forwarding on which a result of the highly sophisticated processing is reflected while preventing the time required to forward the packet from increasing.

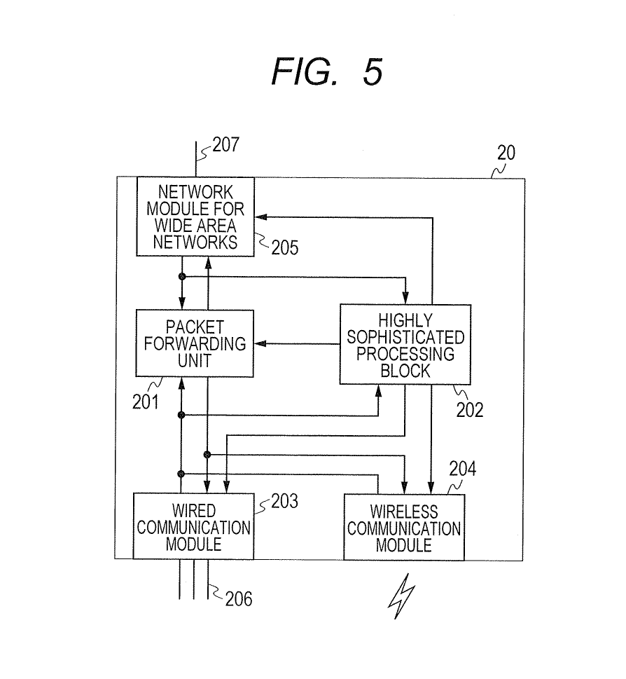

FIG. 5 shows a configuration of the home gateway 20. The home gateway 20 includes a packet forwarding unit 201, a highly sophisticated processing block 202, a wired communication module 203, a wireless communication module 204, and a network module for wide area networks 205. The wired communication module 203 is connected to a wire cable 206 that is connected to a device in the home network 24. The wireless communication module 204 is wirelessly connected to devices in the home network 24. The network module for wide area networks 205 is connected to a line 207 that is connected to a wide area network. A wired line such as an optical fiber cable and a metal cable and a wireless line such as high-speed wireless communication can be applied to the line 207 connected to the wide area network. At least one of the wired communication module 203 and the wireless communication module 204 has to be used.

For example, data received by the wired communication module 203, the wireless communication module 204, and the network module for wide area networks 205 is copied and forwarded to the packet forwarding unit 201 and the highly sophisticated processing block 202. The packet forwarding unit 201 may have the same configuration as that shown in FIG. 2 in the first embodiment. The retrieval unit 1012 of the packet forwarding unit 201 retrieves the header information of the packet by referring to the lookup table 1014 that holds information of the destination, and the packet forwarding unit 201 determines whether the packet is forwarded or discarded. For example, the lookup table 1014 has address information such as transmission source and reception destination (destination) IP addresses and transmission source and reception destination (destination) MAC addresses of a packet, tag information such as a VLAN ID and a label of MPLS, destination information, and information of a filtering condition. The retrieval unit 1012 has a timer and a counter for measuring an arrival frequency and interval in a specific traffic flow according to a filtering condition and discarding a packet according to the filtering condition. In this way, the packet forwarding unit 201 does set or update the filtering condition and performs discard processing by pattern matching according to the condition, so that the packet forwarding unit 201 prevents the time required to forward a packet from increasing while performing high-speed filtering. The lookup table 1014 may further store the QoS information.

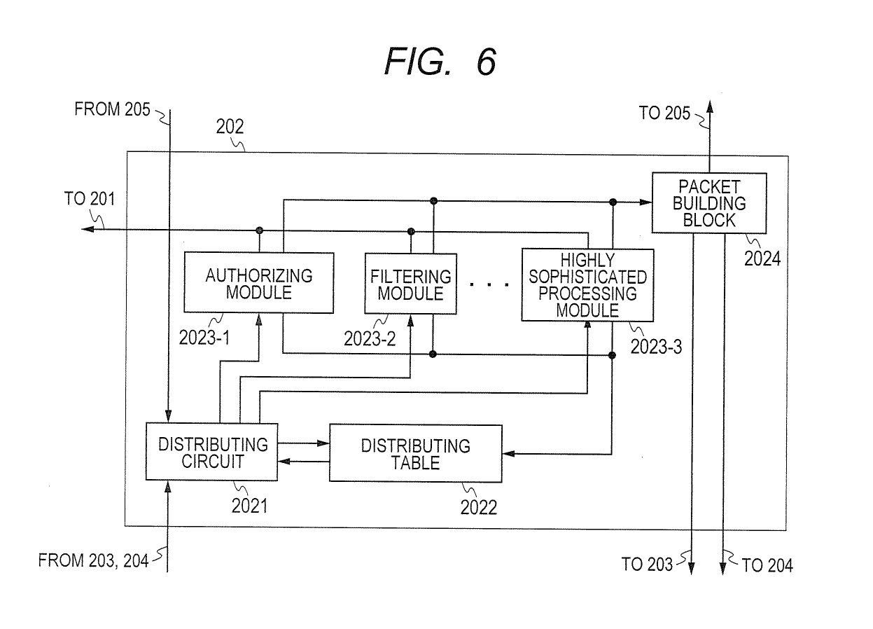

FIG. 6 shows an internal structure of the highly sophisticated processing block 202. The highly sophisticated processing block 202 includes one or more distributing circuits 2021, a distributing table 2022, highly sophisticated processing modules 2023, and a packet building block 2024. Packet data transmitted from the wired communication module 203, the wireless communication module 204, and the network module for wide area networks 205 is first transmitted to a first-stage distributing circuit 2021-1. The distributing circuit 2021-1 searches the distributing table 2022 on the basis of information of the packet, and as a search result, the distributing circuit 2021-1 obtains the destination of the packet or discards the packet. The destination of the distributing circuit 2021-1 is any one of the highly sophisticated processing modules 2023 or another distributing circuit 2021. There are one or more distributing tables which the distributing circuits 2021 search, and there is a case in which the distributing circuits respectively use different tables, a high-speed search is realized by using multiple banks, and/or multiple tables are sequentially searched by combining high-speed but small-sized tables and low-speed but large-sized tables considering efficiency and speed of the search.

In the distributing table 2022, for example, an area of the packet to be a search target (search key) can be specified for each distributing circuit 2021. For example, information used as the search key is specified in advance in the header information of the packet. In the distributing table 2022, identification information of one or more destination modules is stored corresponding to the search key specified in advance in the header information of the packet. Pattern matching is performed for each search target area corresponding to the distributing circuit 2021 by using the distributing table 2022. The distributing circuit selects a destination module according to a result of the pattern matching; however, the distributing circuit may select multiple destination modules.

The distributing circuit 2021 may include a buffer for storing a main body of the packet. To perform multiple retrievals sequentially in this way, the buffer can be shared by multiple distributing circuits 2021.

The highly sophisticated processing modules 2023 respectively having different functions corresponding to an application to be used are arranged. Examples of the highly sophisticated processing modules include an authorizing module 2023-1 and a filtering module 2023-2. The highly sophisticated processing modules respectively have different configurations according to an application to be used, a range of data, and the like. Further, among the highly sophisticated processing modules, multiple modules having the same function are prepared, and the multiple modules can be activated according to a difference of the traffic distributed by the distributing table 2022.

Each of the highly sophisticated processing modules 2023 has a connection with the packet forwarding unit 201 for rewriting information in the lookup table in the packet forwarding unit 201, a line for rewriting information in the distributing table 2022, and a connection with the packet building block 2024 for transmitting the packet to the outside. Each of the highly sophisticated processing modules 2023 may have a lookup table, a timer, and the like according to processing contents thereof.

The packet building block 2024 adds a packet header to the packet and forwards the packet according to a request from the highly sophisticated processing modules 2023. The packet building block 2024 has connections with the wired communication module 203, the wireless communication module 204, and the network module for wide area networks 205, and the packet can be transmitted from each module. To realize the above function, the packet building block 2024 includes a search engine, a packet buffer, a lookup table, a header creating engine, and the like for analyzing contents of a destination requested by the highly sophisticated processing modules and searching for the destination to which the packet is outputted from an appropriate port. The packet building block 2024 may output the packet to the packet forwarding unit 201 and the packet forwarding unit 201 may output the packet by searching the lookup table in the same manner as for a normal packet.

The highly sophisticated processing block 202 is configured as described above, so that the packet can be analyzed independently from the packet forwarding unit 201 that performs a normal packet forwarding process and various processes can be performed. Also, a packet is created and forwarded on the basis of the highly sophisticated processing in a manner different from a normal packet forwarding, so that it is possible to communicate with any device such as another highly sophisticated processing node, various terminals, and a sensor that transmits data. Further, the result of the processing of the highly sophisticated processing block 202 is fed back to the packet forwarding unit 201, so that it is possible to control the forwarding to which the highly sophisticated processing is applied while reducing the delay time required for the highly sophisticated processing. At this time, the delay time of the forwarding is reduced by forwarding an arrived packet first, so that the control of the forwarding is applied after the packet that triggers the control has been forwarded. However, in an example of a sensor network in which it is expected that traffic is periodically generated from the same transmission source, there is a case in which reduction of the delay time has priority over application of the control of the forwarding, and this method is particularly effective in such a network.

Next, an example of the highly sophisticated processing modules 2023 and an example of a service using the highly sophisticated processing modules 2023 will be described.

First, an example of an authorizing system using an authorizing module 2023-1 will be described. The example of the authorizing system will be described assuming that a packet forwarded from the network module for wide area networks 205 is authenticated to communicate with a device in the home network 24. In other words, the authorizing system determines whether or not communication from outside is authenticated to access a specific device in a home.

The packet forwarding unit 201 forwards or discards a received packet according to filtering information. An authorizing processing module 2023-1 performs authorizing processing on the received packet, and updates filtering information of the packet forwarding unit 201 according to the authorizing result.

The home gateway 20 of the present system starts from a state in which all received traffic is not authenticated in an initial state. When a received traffic is not authenticated, the traffic is discarded. More specifically, the filtering information is set in advance in the packet forwarding unit 201 so that an unauthenticated packet is discarded. In other words, traffic transmitted for the first time is discarded without exception in a normal forwarding system and the traffic is authenticated while the traffic is being discarded. If the traffic is authenticated, the traffic is forwarded.

Whether or not the traffic is discarded is determined on the basis of the information in the lookup table in the packet forwarding unit 201. On the other hand, the packet of the traffic forwarded to the highly sophisticated processing block 202 as well as the packet forwarding unit 201 is determined to be authenticated by the distributing circuit 2021 and forwarded to the authorizing module 2023-1. The authorizing module 2023-1 determines whether or not there is access authority from the information of the packet. When the authorizing module 2023-1 provides access authority, the authorizing module 2023-1 communicates with the packet forwarding unit 201, rewrites the lookup table, and allows communication of the traffic to the home network 24. Even while the authorizing processing module 2023-1 performs authorizing processing, the other packets that have already been authenticated can be processed in parallel in the packet forwarding unit 201.

Further, if a change of authority needs to be continuously monitored, the authorizing processing module 2023-1 monitors packets transmitted from the distributing circuit 2021, and when a change of access authority or the like occurs, the authorizing module 2023-1 communicates with the packet forwarding unit 201 and rewrites the lookup table. On the other hand, if a change of authority need not be monitored, the authorizing processing module 2023-1 can rewrite the information in the distributing table 2022 and change a distributing policy.

The authorizing processing module 2023-1 can have a packet buffer as needed and store packets that are discarded in a normal data forwarding system according to the type of authorizing and the address information. These unauthenticated packets having the same transmission source are discarded or forwarded when the authorizing is completed. Specifically, the packets that are not authenticated are discarded, and packets which are authenticated but have low importance, that is, packets that are determined to be important when they are new but meaningless to be forwarded when they are old, are discarded. On the other hand, communication in which all packets are required to be forwarded even if their arrivals are delayed is performed. Whether the stored packet is discarded or forwarded is determined in advance according to, for example, the type of authorizing, the address information of the packet, the identification information indicating a packet flow, and the like. Thereby, it is possible to implement a function for determining a condition of storing and forwarding a packet by combining a first-stage determination whether or not to temporarily store the packet and a second-stage determination of information obtained from the actual authorizing on the basis of information such as the type of the authorizing and the address information.

When communication is required for the authorizing processing module 2023-1 to determine whether or not a packet is authenticated, the authorizing processing module 2023-1 performs communication via the packet building block 2024. The authorizing processing module 2023-1 may communicate with the data center 22, the network node 21, and devices in the home network 24.

When the present authorizing system is used, the delay time of the device can be shorter than that when the authorizing is performed in a conventional network node. In a conventional network node, a packet to be authenticated is forwarded to an authorizing module via a packet forwarding unit and the packet is forwarded after the authorizing result is obtained. Therefore, when only an authorizing system is introduced, the delay time when a packet passes through the network node increases. It is possible to prevent the delay time from increasing by using the present method.

Next, an example of a filtering processing system using a filtering module 2023-2 will be described. An object of the present system is to reduce loads of the network node 21 and the data center 22 by appropriately filtering data transmitted from the home network 24 to the wide area network 23 so that redundant traffic is prevented from occurring and only appropriate data is transmitted. The filtering processing described here is not limited to discarding all or part of the packets but includes various calculation operations to reduce the total amount of traffic.

A packet of traffic transmitted from the home network 24, which is received and forwarded by the wired communication module 203 and the wireless communication module 204, is transmitted to a wide area network line 207 via the packet forwarding unit 201 and the network module for wide area networks 205. The filtering module 2023-2 rewrites the information in the lookup table of the packet forwarding unit 201 on the basis of a policy, so that the filtering module 2023-2 can perform filtering of a packet to be filtered. Examples of the filtering include a case in which the entire packet is blocked, a case in which the QoS information is rewritten and only the priority is controlled, a case in which only a specific percentage of packets among the arrived packets are forwarded, and a case in which forwarding is allowed at a predetermined period of time. However, a filtering operation that can be performed by the packet forwarding unit 201 depends on a level of the search engine and the retrieval unit of the packet forwarding unit 201.

Further highly sophisticated filtering is performed by the filtering module 2023-2. Specifically, when highly sophisticated filtering is performed in which contents of the packet are determined and filtering is performed, the packet forwarding unit 201 discards the entire packet and the forwarding processing is performed by the filtering module 2023-2 instead of the packet forwarding unit 201. For example, in the packet forwarding unit 201, the filtering information is set in advance so that a packet of first traffic is discarded. The packet of the first traffic is discarded by the packet forwarding unit 201 and filtered by the filtering module 2023-2 of the highly sophisticated processing block 202. A packet of second traffic different from the first traffic is filtered by the packet forwarding unit 201 according to the filtering information.

In this case, for example, the filtering module 2023-2 transmits the packet via the packet building block 2024. The filtering operation performed by the filtering module 2023-2, which is higher sophisticated than the filtering operation performed by only the packet forwarding unit 201, is, for example, a filtering processing that generates another packet using multiple packets. For example, in the filtering operation, packets in a predetermined period of time are stored and a packet is generated in which an average value of appropriate data of the packets and data of multiple different traffic flows are integrated. The filtering module 2023-2 can control data to which the filtering module 2023-2 refers by rewriting contents in the distributing table 2022. Thereby, for example, the filtering module 2023-2 can set and change the policy of the filtering by referring to packets other than the packet to which the filter is applied.

To perform such a process, the filtering module 2023-2 includes a dedicated packet buffer that can store packets to be filtered in a predetermined period of time inside thereof. This is because the packet buffer is necessary to perform the filtering processing that generates another packet using multiple packets and a process is required in which a packet is stored while determining whether or not the packet has to be forwarded and the packet is read when the packet is forwarded. When packets are discarded by the packet forwarding unit 201, the packets to be filtered are stored in the buffer for a certain period of time. Thereby, when the filtering policy of the packets to be filtered, which are discarded by the packet forwarding unit 201, is changed, the packets discarded by the time when the filtering condition is changed can be complementarily forwarded from the filtering module 2023-2. Therefore, the size of the buffer included in the filtering module 2023-2 can be a size in which all the packets generated in a period of time required to rewrite the information in the lookup table of the forwarding unit 201 can be stored.

The filtering function more contributes to reduce the delay time when a simple filtering that can be performed by the packet forwarding unit 201 is applied than a conventional filtering method. Further, in the conventional filtering method, when traffic to be a condition of control of filtering is different from traffic to be controlled, a delay occurs in both the former traffic and the latter traffic. By using the present method, even when high-level control is performed, it is possible to prevent a delay of the traffic to be a condition of control from occurring.

Examples of the highly sophisticated processing module other than the above include various sophisticated modules such as a sophisticated module that monitors the amount of traffic, a sophisticated module that stores a specific packet, and a sophisticated module that checks payload and transmits a packet to notify another device of the payload.

In the highly sophisticated processing modules 2023 as described above, modules to be used vary depending on an application to be used and a network environment. These modules may include a CPU that operates using software, a set of memories, and a dedicated hardware chip inside thereof. Also, these modules may use hardware such as a drive for recording information. These modules may be mounted inside the device in advance, or may be realized as extension boards that can be added from the outside.

### Third Embodiment

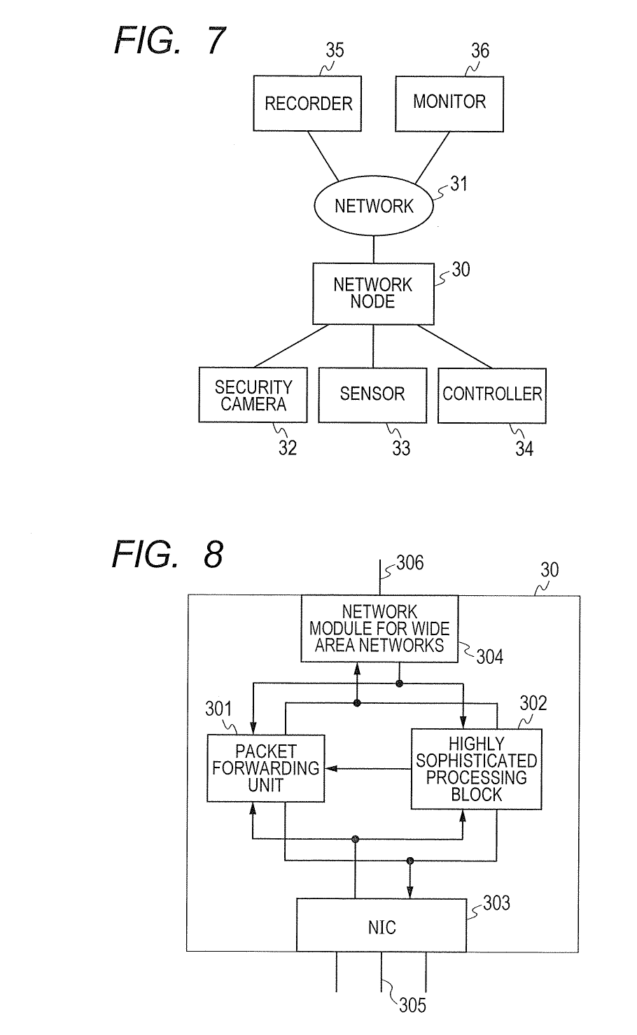

FIG. 7 shows a configuration of another embodiment of the present invention.

The present system includes a network node 30, a network 31 to which the network node 30 connects, a security camera 32 for performing monitoring by an image, a sensor 33 for measuring data of an object to be monitored, a controller 34 for controlling the object to be monitored, a recorder 35 for storing data of the object to be monitored, and a monitor 36 which displays an image and information of the sensor or the like and by which an administrator controls the devices from a remote location. The present invention can be applied to the network node 30.

For example, the present system is a monitoring/controlling system for monitoring and controlling an industrial device via the network 31. The security camera 32, the sensor 33, and the controller 34 are respectively connected to the network node 30 and located near a device to be controlled. The network node 30 is connected to the recorder 35 and the monitor 36 via the network 31.

FIG. 8 shows a configuration of the network node 30. The network node 30 includes a packet forwarding unit 301, a highly sophisticated processing block (packet processing unit) 302, a NIC 303, and a network module for wide area networks 304. The NIC 303 is connected to a network line 305 that is connected to the security camera 32, the sensor 33, and the controller 34. The network module for wide area networks 304 is connected to a wide area network line 306 that is connected to the network 31.

When the network node 30 receives a packet via the network line 305, the network node 30 copies the packet through the NIC 303 and forwards the packet to the packet forwarding unit 301 and the highly sophisticated processing block 302. The packet received here includes, for example, data (sensor data) measured by the sensor 33. Similarly, a packet received from the wide area network line 306 is copied through the network module for wide area networks 304 and forwarded to the packet forwarding unit 301 and the highly sophisticated processing block 302. The packet forwarding processing by the packet forwarding unit 301 and the processing by the highly sophisticated processing block 302 are performed in parallel.

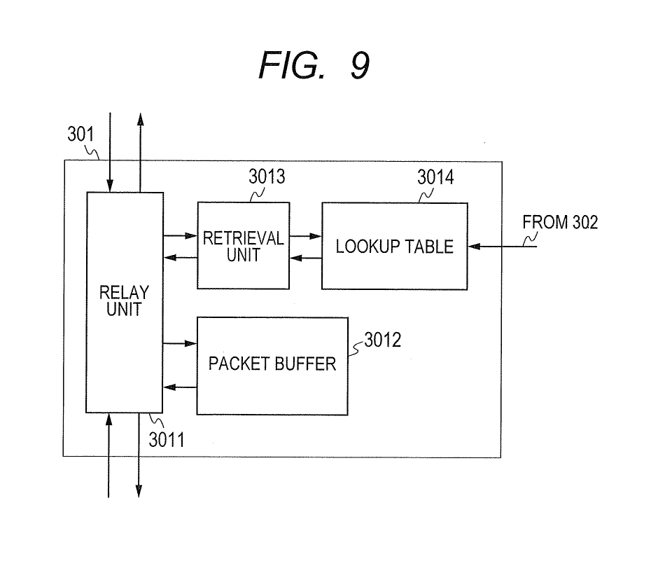

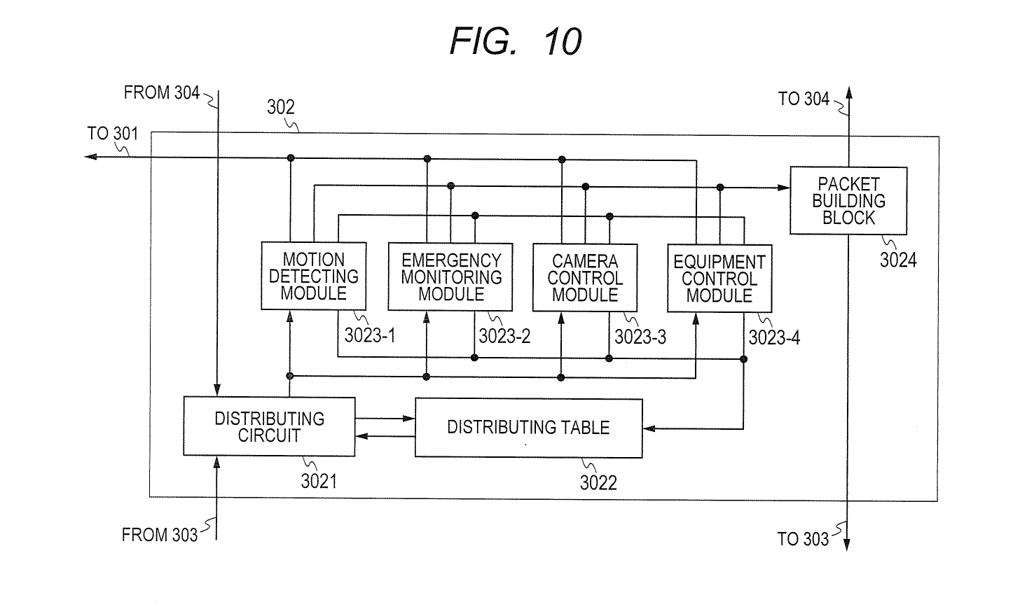

FIG. 9 shows a configuration of the packet forwarding unit 301. The packet forwarding unit 301 includes a packet buffer 3012 for storing a packet, a retrieval unit 3013 that performs a search based on header information of the packet, a relay unit 3011 that extracts the header information and forwards the header information to the retrieval unit 3013 while relaying the packet transmitted from the NIC 303 and the network module for wide area networks 304 to the packet buffer 3012, and a lookup table 3014 that is a memory for storing information which the retrieval unit 3013 retrieves the destination information and the like.

When the relay unit 3011 receives a packet, the relay unit 3011 forwards information of the packet header to the retrieval unit 3013 while storing the packet in the packet buffer 3012. The retrieval unit 3013 searches the lookup table 3014 on the basis of the information of the packet header and receives search results such as the destination and the QoS information. The retrieval unit 3013 that receives the search results determines processing contents of the packet on the basis of the search results and transmits the processing contents to the relay unit 3011. The relay unit 3011 reads the packet data stored in the packet buffer 3012 and forwards the packet data to an appropriate destination or discards the stored packet data on the basis of the received processing contents. The lookup table 3014 is connected to the highly sophisticated processing block 302 and accepts a request for rewriting the information on the table.

FIG. 10 shows a configuration of the highly sophisticated processing block 302. The highly sophisticated processing block 302 includes a distributing circuit 3021 that receives a packet forwarded from the NIC 303 and the network module for wide area networks 304 and distributes the packet, a distributing table 3022 which the distributing circuit 3011 searches to distribute the package, highly sophisticated processing modules 3023 that are destinations to which the distributing circuit 3021 forwards the packet, and a packet building block 3024 that generates a packet according to a request from the highly sophisticated processing modules 3023 and forwards the packet to the NIC 303 and the network module for wide area networks 304.

The distributing circuit 3021 that receives a packet determines a highly sophisticated processing module 3023 that is the destination by searching the distributing table 3022, and forwards the packet on the basis of the determination result. In the present system, the information forwarded to the distributing table 3022 is the header information of the packet, and the packet is forwarded according to the type of the transmission source and appropriate parameters in the header information on the basis of the header information.

The highly sophisticated processing modules 3023 include, for example, a motion detecting module 3023-1, an emergency monitoring module 3023-2, a camera control module 3023-3, and an equipment control module 3023-4. Each module is connected to the lookup table 3014 of the packet forwarding unit 301, the distributing table 3022, and the packet building block 3024. Each highly sophisticated processing module 3023 is connected to each other and can communicate with each other.

The motion detecting module 3023-1 receives an image packet of the security camera 32 and detects whether or not the camera image is moving. Therefore, the motion detecting module 3023-1 has a buffer for storing image data of the packets received within a certain period of time and detects the motion of the image of the security camera 32 on the basis of a rate of change obtained by comparing with past image data. When the motion detecting module 3023-1 detects a motion, the motion detecting module 3023-1 forwards information indicating that a motion is detected to other modules. Also, the motion detecting module 3023-1 transmits a packet notifying that a motion is detected to the monitor 36 through the packet building block 3024.

An object of the emergency monitoring module 3023-2 is to receive data of the sensor 33 and detect abnormality of an object to be monitored from the value of the data. Specifically, when the emergency monitoring module 3023-2 detects abnormal temperature or humidity, depending on the degree of the abnormality, the emergency monitoring module 3023-2 transmits the detection result to the other highly sophisticated processing modules 3023, and further transmits the detection result to the controller 34 and the monitor 36 via the packet building block 3024. For example, the abnormality can be detected when the data from the sensor 33 is greater than (or smaller than) a predetermined threshold value. However, the abnormality can be detected in a manner other than the above. The degree (level) of the abnormality may be detected by setting multiple threshold values. The monitor 36 notifies the administrator of the abnormality by showing an appropriate abnormality display. Further, the emergency monitoring module 3023-2 rewrites information of the lookup table 3014 and the distributing table 3022 of the packet forwarding unit 301, so that the emergency monitoring module 3023-2 changes the type of the data to be forwarded, the frequency of forwards, the QoS, and the like.

The camera control module 3023-3 changes the orientation of the security camera 32, the resolution of an image, and the frame rate on the basis of a request from the monitor 36 and information from the motion detecting module 3023-1 and the emergency monitoring module 3023-2. When the camera control module 3023-3 detects that the camera needs to be controlled, the camera control module 3023-3 transmits a control packet to the security camera 32 via the packet building block 3024. The camera control module 3023-3 monitors a packet transmitted from the security camera 32, so that the camera control module 3023-3 checks whether the control of the security camera 32 is correctly performed. Further, the camera control module 3023-3 rewrites information of the lookup table 3014 and the distributing table 3022 of the packet forwarding unit 301 in accordance with the control of the image of the security camera 32.

The equipment control module 3023-4 controls a device to be monitored on the basis of information of packets forwarded from the controller 34 and the monitor 36 and information from the motion detecting module 3023-1 and the emergency monitoring module 3023-2. The equipment control module 3023-4 transmits a control message to the controller 34 via the packet building block 3024.

The above-described motion detecting module is not limited to a module that detects a motion by a camera, but may be a module that detects a difference by comparing sensor data at different times using sensor data of multiple packets received at different times. Although a considerable time is required to perform a process based on multiple packets, in the present embodiment, the forwarding processing and the highly sophisticated processing are separated from each other, so that it is possible to realize both the quick packet forwarding and the highly sophisticated packet processing.

As a result of the present system, the network node 30 can monitor information of the security camera 32 and the sensor 33 and reflect the result of the monitoring on the control of the security camera 32 and the controller 34. For example, the network node can process a packet and transmit a control packet to the security camera 32 and the controller 34, so that response is quicker than that in a case in which data is transmitted to a higher level device via the network 31 and a processing result is received. Further, as a result of the monitoring, it is possible to control the amount of traffic flowing in the network 31 and transmit various information to the monitor 36. On the other hand, these highly sophisticated processes are performed, so that data transmitted from the security camera 32 and the sensor 33 can be forwarded to the recorder 35 and the monitor 36 with a minimum delay at the packet forwarding unit 301, whereas the data is forwarded with a certain delay in a conventional system.

### Fourth Embodiment

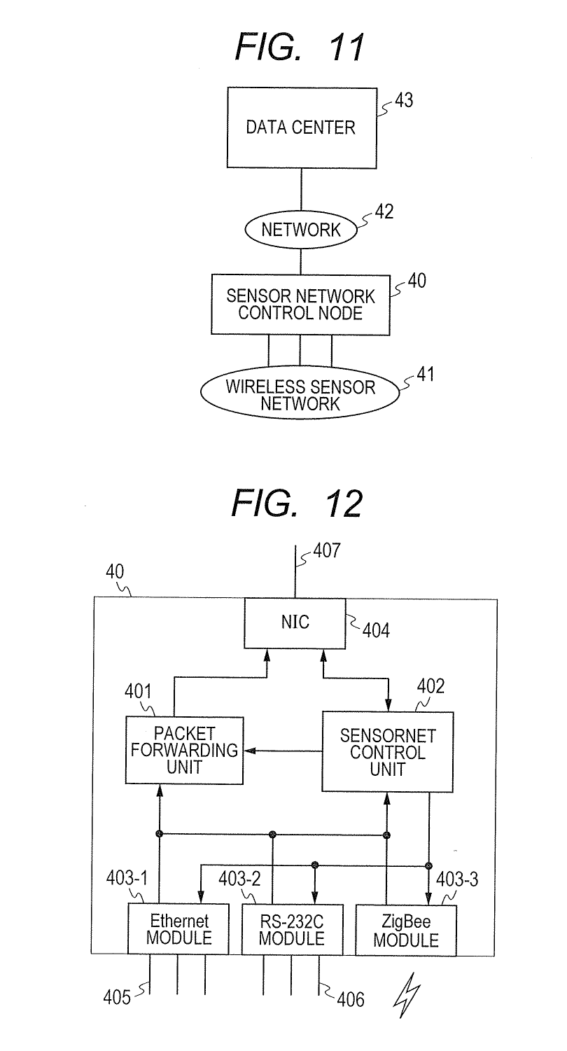

FIG. 11 shows a configuration of another embodiment of the present invention. For example, the present invention is applied to a sensor network control node 40.

The sensor network control node 40 forwards various data generated from the wireless sensor network 41 to the data center 43 via the network 42.

The wireless sensor network 41 includes various sensors and forwards information of the sensors to the sensor network control node 40. The wireless sensor network 41 is directly controlled by a control signal transmitted from the sensor network control node 40.

FIG. 12 shows a configuration of the sensor network control node 40. The sensor network control node 40 includes a packet forwarding unit 401, a sensornet control unit 402, multiple network modules (first interface) 403, and a NIC (second interface) 404.

As examples of the multiple network modules 403, an Ethernet module 403-1 (Ethernet is a registered trademark), an RS-232C module 403-2, a ZigBee module 403-3, and the like can be used. The multiple network modules communicate with the wireless sensor network 41 via an Ethernet line 405, an RS-232C cable 406, or wireless communication respectively.

The NIC 404 is connected to a network line 407 that is connected the network 42 which connects between the sensor network control node 40 and the data center 43.

The sensor network control node 40 has characteristics that the sensor network control node 40 does not directly forwarding traffic from the network 42 to the downstream side. Also, the sensor network control node 40 does not directly forwarding traffic from the wireless sensor network 41. Therefore, a packet inputted from the NIC 404 of the sensor network control node 40 is forwarded to only the sensornet control unit 402, an output of the packet forwarding unit 401 is forwarded to only the NIC 404, and packet headers of all packets which are received from the network modules 403 and inputted into the packet forwarding unit 401 are rewritten.

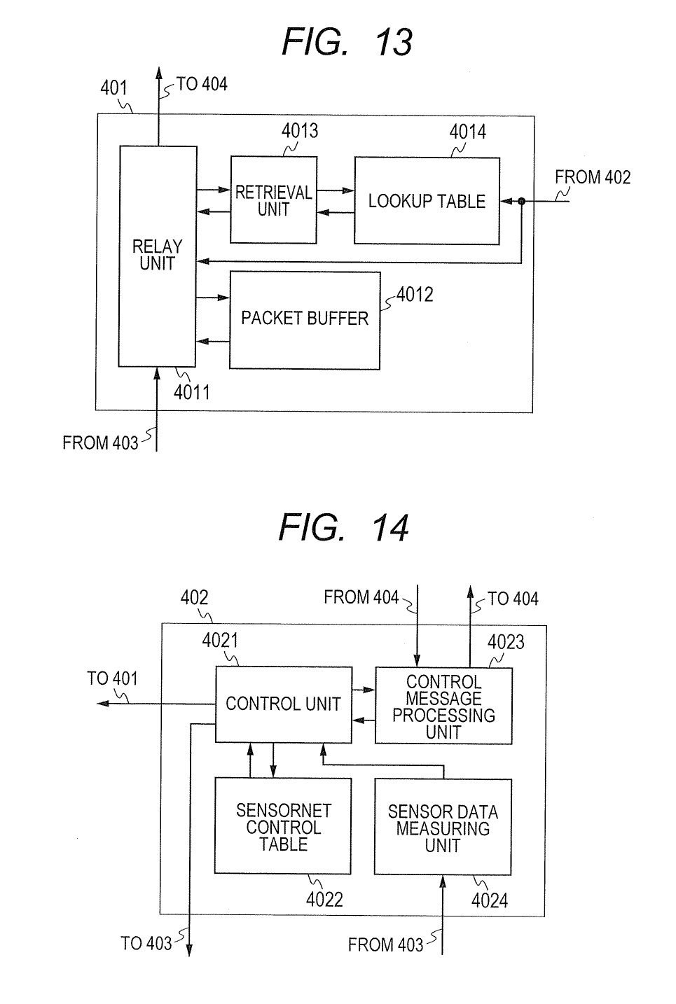

FIG. 13 shows a configuration of the packet forwarding unit 401. The packet forwarding unit 401 has a relay unit 4011 which receives a packet from the network modules 403 and forwards the packet to the NIC 404. The relay unit 4011 stores the packet in a packet buffer 4012 and forwards the header information to a retrieval unit 4013. The retrieval unit 4013 refers to a lookup table 4014 and retrieves information related to processing contents of the packet. At this time, the retrieval unit 4013 does not search for information of the destination of the packet, but retrieves a condition related to filtering of the packet and information related QoS. Specifically, the retrieval unit 4013 returns information indicating whether or not the packet is discarded and information related to the forwarding priority to the relay unit 4011.

The relay unit 4011 that receives a search result from the retrieval unit 4013 performs processing according to the search result. When the relay unit 4013 forwards the packet, the relay unit 4013 reads the packet stored in the packet buffer 4012 and rewrites the header of the packet. The information related to the destination of the packet is unique data (for example, data center 43) which does not depend on the packet, and transmitted to the relay unit 4011 from the sensornet control unit 402 only when the information is changed. Also, the sensornet control unit 402 forwards a packet written in the lookup table 4014 and rewrites information related to QoS.

FIG. 14 shows a configuration of the sensornet control unit 402. The sensornet control unit 402 includes a control unit 4021, a sensornet control table 4022, a control message processing unit 4023, and a sensor data measuring unit 4024. The control unit 4021 searches and rewrites the sensornet control table 4022. The control unit 4021 is connected to the control message processing unit 4023 and the sensor data measuring unit 4024, and manages sensors belonging to the sensor network.

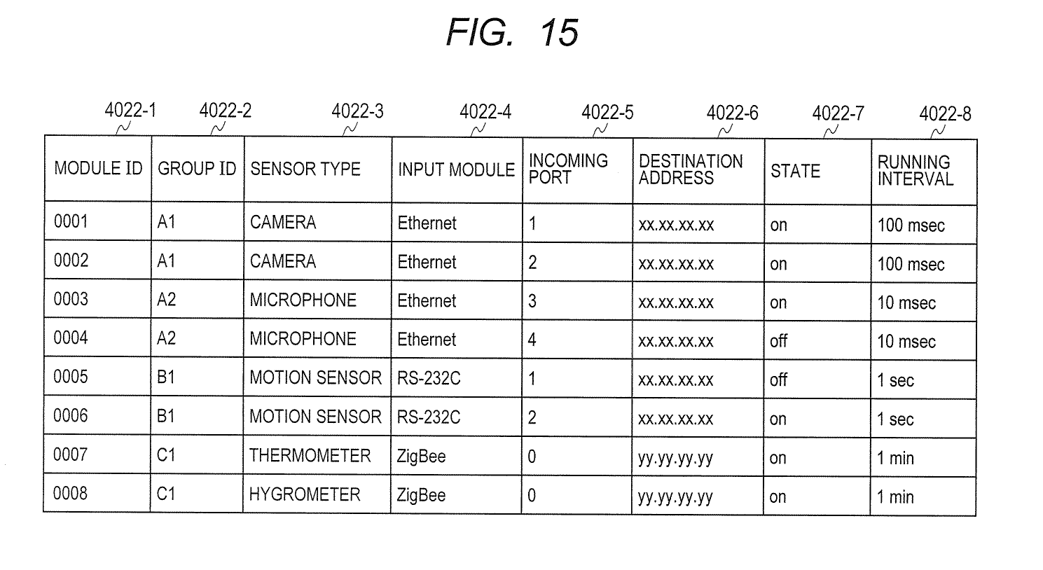

FIG. 15 shows a configuration of the sensornet control table 4022. The sensornet control table 4022 stores sensor information of the sensor network and has table information including a module ID 4022-1 for managing each sensor individually, a group ID 4022-2 for collectively managing sensors, a sensor type 4022-3 indicating a format of data transmitted by the sensor, an input module 4022-4 indicating a type of module connected to the sensor, an incoming port 4022-5 indicating a port of input module, to which the sensor is connected, a destination address 4022-6 indicating address information of the data center to which sensor data is transmitted, a state 4022-7 indicating whether or not the sensor operates, and a running interval 4022-8 at which data is transmitted when the sensor operates. The control unit 4021 determines whether or not an error occurs in statistical information of the sensors from the table information.

A packet (for example, a control packet) transmitted from the data center 43 is forwarded to the control message processing unit 4023 via the NIC 404. The control message processing unit 4023 determines the control contents of the received packet and transmits the control contents to the control unit 4021. When the control unit 4021 receives the control contents from the control message processing unit 4023, the control unit 4021 reads corresponding information from the sensornet control table 4022, determines whether or not to perform the control, and rewrites the control table.

On the other hand, when the control unit 4021 detects abnormality of statistical information or performs control such as rewriting the control table, if needed, the control unit 4021 notifies the data center 43 accordingly via the control message processing unit 4023. At this time, if the control contents are to transmit a control message to a sensor in the wireless sensor network 41, the control unit 4021 transmits the message via the network module 403. If the control contents are to rewrite the relay unit 4011 or the lookup table 4014 of the packet forwarding unit 401, the control unit 4021 transmits a message to the packet forwarding unit 401.

The sensor data measuring unit 4024 monitors sensor data received by the network module 403. Specifically, the sensor data measuring unit 4024 detects the time interval of packet arrivals for each type of sensor, and periodically transmits sensor survival information to the control unit. To perform the monitoring, the sensor data measuring unit 4024 has a function as a timer for detecting a certain period of time and a function as a counter and a memory for counting the number of packets arriving in a certain period of time and collecting the transmission source addresses of the packets. The addresses and the number of the arriving packets are periodically transmitted to the control unit 4021 as statistical information. When abnormality is detected in sensor data, a message is transmitted to the control unit 4021. When the control unit 4021 receives the statistical information or the message indicating abnormality, the control unit 4021 compares the statistical information or the message with sensor control data stored in the sensornet control table 4022, and transmits a message to the data center 43 via the control message processing unit 4023 as needed. The sensor data measuring unit 4024 has a role to identify a message related to control from a sensor and forward the message to the control unit 4021.

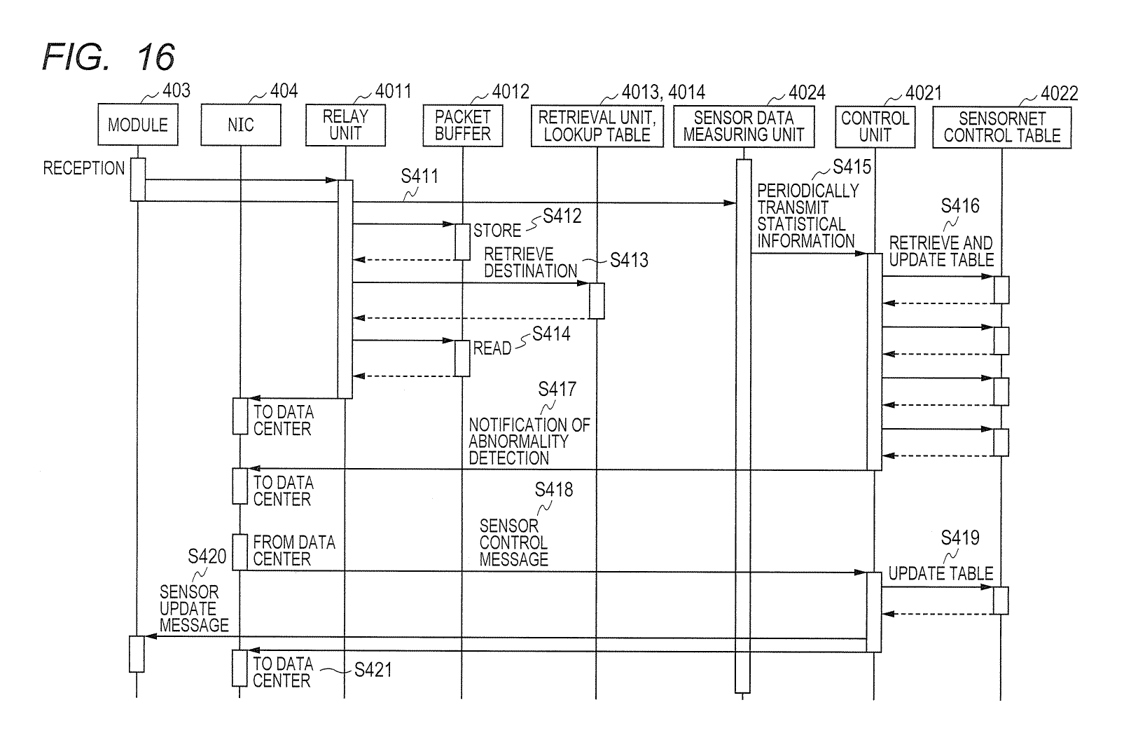

FIG. 16 shows an example of a process flow in the sensor network control node 40. The sensor information is received by the module 403, and then forwarded to the relay unit 4011 and the sensor data measuring unit 4024 (S411). The relay unit 4011 forwards the data to the data center in conjunction with the packet buffer 4011, the retrieval unit 4013, and the lookup table 4014 (S412 to S414). On the other hand, the sensor data measuring unit 4024 extracts statistical information from the arrived data and periodically transmits the extraction result to the control unit 4021 (S415). The control unit 4021 searches the sensornet control table on the basis of the arrived statistical information and monitors whether or not there is abnormality (S416). In FIG. 16, after detecting abnormality, the control unit determines that it is necessary to transmit a message to the data center 43, and transmits a message notifying that abnormality is detected (S417). A sensor control message transmitted from the data center 43 is transmitted to the control unit 4021 (S418), and the control unit 4021 updates the sensornet control table 4022 (S419) and transmits a sensor update message to update an operation of a sensor via the module 403 (S420). The control unit 4021 completes the update by returning a notification related to a result of the update to the data center (S421).

By using the above configuration, the sensor network control node 40 can perform both the high-speed data forwarding of the wireless sensor network 41 and the monitoring of the sensor survival information. Further, the sensor network control node 40 separates the traffic transmitted from the data center 43 from the traffic transmitted from the wireless sensor network 41, so that the sensor network control node 40 can prevent a possibility that a control message is discarded when the sensor data increases.

### Configuration Example

The network node of the present embodiment is, for example, a network node having a function to connect to a network and communicate with the network, and can perform a packet forwarding processing function for determining a destination of a received packet and a function using the received packet other than the packet forwarding processing function in parallel.

The network node described above has, for example, a feature in which the function using the received packet other than the packet forwarding processing function is a function that uses a result of a search in which part or all of the received packet is used as a search key.

The network node described above has, for example, a feature in which the function that uses a result of a search in which part or all of the received packet is used as a search key changes contents of the processing performed according to the result of the search.

The network node described above has, for example, a feature in which the function that uses a result of a search in which part or all of the received packet is used as a search key affects the result of the packet forwarding processing function for determining a destination of a received packet.

The network node described above has, for example, a feature in which the function that uses a result of a search in which part or all of the received packet is used as a search key generates a packet and transmits the packet to a device other than the network node.

The network node described above has, for example, a feature in which the function that uses a result of a search in which part or all of the received packet is used as a search key refers to a forwarding state of the packet in the packet forwarding processing function.

The network node described above has, for example, a feature in which the function using the received packet other than the packet forwarding processing function is a function that uses information of the number of the received packets and the byte lengths of the packets.

The network node described above has, for example, a feature in which the function that uses information of the number of the received packets and the byte lengths of the packets affects the result of the packet forwarding processing function for determining a destination of a received packet.

The network node described above has, for example, a feature in which the function that uses information of the number of the received packets and the byte lengths of the packets generates a packet and transmits the packet to a device other than the network node.

The network node described above has, for example, a feature in which the function that uses information of the number of the received packets and the byte lengths of the packets refers to a forwarding state of the packet in the packet forwarding processing function.

The network node described above has, for example, a feature in which the network node generates a packet and transmits the packet to a device other than the network node by referring to the forwarding state of the packet.

The present invention can be used for, for example, a network node having highly sophisticated processing capability other than forwarding processing.

What is claimed is:

1. A network node comprising:
an interface that receives a packet including sensor data measured by a sensor;
a packet forwarding unit that performs packet forwarding processing for forwarding the received packet; and
a packet processing unit that performs at least predetermined processing other than the packet forwarding processing on the sensor data included in the received packet,
wherein the received packet is inputted into the packet forwarding unit and the packet processing unit respectively, and
wherein the packet forwarding processing by the packet forwarding unit and the processing by the packet processing unit are performed in parallel.

2. The network node according to claim 1, wherein the packet processing unit performs processing by using sensor data of a plurality of packets received at different times.

3. The network node according to claim 2, wherein the packet processing unit compares the sensor data of different times and detects a difference.

4. The network node according to claim 3, wherein the packet processing unit has a motion detecting module that stores packets including sensor data from a camera and detects a motion by comparing sensor data of different times.

5. The network node according to claim 1, wherein the packet processing unit has an emergency monitoring module that detects abnormality of an object to be monitored by the sensor on the basis of sensor data.

6. The network node according to claim 5, wherein, when the emergency monitoring module detects an abnormality, the emergency monitoring module notifies a controller that controls an object to be monitored or a monitor that notifies an administrator of an abnormality that the abnormality is detected.

7. The network node according to claim 1,
wherein one of the sensors is a camera, and
wherein the packet processing unit has a camera control module that controls one or more of an orientation of the camera, a resolution of an image, and a frame rate according to a request from another device or a processing result of the sensor data.

8. The network node according to claim 1, wherein the packet processing unit has an equipment control module that transmits a control signal to a controller that controls a device to be monitored according to a request from another device or a processing result of the sensor data.

9. The network node according to claim 2, wherein the packet processing unit obtains statistical information of sensor data of packets received within a predetermined period of time.

10. A network node comprising:
a first interface that receives a packet including sensor data measured by a sensor;
a second interface that communicates with a data center;
a packet forwarding unit that performs packet forwarding processing for forwarding a packet received by the first interface to the data center via the second interface; and
a packet processing unit that performs at least predetermined processing other than the packet forwarding processing on the sensor data included in the packet received by the first interface and processes a control packet that is received from the data center by the second interface,
wherein the packet received by the first interface is inputted into the packet forwarding unit and the packet processing unit respectively,
wherein the packet forwarding processing by the packet forwarding unit and the processing by the packet processing unit are performed in parallel, and
wherein the control packet received by the second interface is inputted into the packet processing unit and processed by the packet processing unit.

11. A network node comprising:
a packet forwarding unit in which filtering information to determine whether a packet is allowed to be forwarded or discarded is stored and which determines whether a received packet is allowed to be forwarded or discarded by referring to the filtering information and performs packet forwarding processing for forwarding a packet allowed to be forwarded according to destination information; and
a packet processing unit that performs at least predetermined processing other than the packet forwarding processing on a received packet,
wherein a received packet is inputted into the packet forwarding unit and the packet processing unit respectively,
wherein the packet forwarding processing by the packet forwarding unit and the processing by the packet processing unit are performed in parallel, and
wherein the destination information and/or the filtering information are updated according to a result of the processing and the packet forwarding processing is performed on a packet received thereafter by referring to the updated destination information and/or filtering information.

12. The network node according to claim 11,
wherein the predetermined processing is authorizing processing,
wherein the packet forwarding unit forwards or discards a received packet according to the filtering information, and
wherein the packet processing unit has an authorizing processing module that performs the authorizing processing on the received packet and updates the filtering information of the packet forwarding unit according to an authorizing result.

13. The network node according to claim 12,
wherein the filtering information is set in advance in the packet forwarding unit so that an unauthenticated packet is discarded, and
wherein the authorizing processing module of the packet processing unit has a first packet buffer to store an unauthenticated packet and forwards the unauthenticated packet after the authorizing.

14. The network node according to claim 13,
wherein, whether or not an unauthenticated packet is stored in the packet buffer is specified for each type of authorizing and/or address information of a packet in the packet processing unit, and
wherein the packet processing unit determines whether or not a received packet to be stored in the packet buffer according to a type of authorizing and/or address information of a packet included in the received packet.

15. The network node according to claim 11,
wherein the packet processing unit further includes a filtering module for performing filtering based on a plurality of packets on a packet of first traffic,
wherein the filtering information is set in advance in the packet forwarding unit so that a packet of first traffic is discarded,
wherein a packet of the first traffic is discarded by the packet forwarding unit and filtered by the packet processing unit, and
wherein a packet of second traffic different from the first traffic is filtered by the packet forwarding unit according to the filtering information.
